(19) United States
(12) Patent Application Publication
(10) Pub. No.: US 2005/0146123 A1
(43) Pub. Date: Jul. 7, 2005

(54) Gas generator

(75) Inventors: Maximilian Bergmann, Laaber (DE); Achim Hofmann, Polling (DE); Jens Holzapfel, Broebberow (DE); Lorenz Seidl, Freimehring (DE); Monika Seddig, Laage (DE); Christian Jung, Muehldorf (DE); Wolfgang Tengler, Oberwoessen (DE); Andreas Spitzenberg, Aschau am Inn (DE)

Correspondence Address: TAROLLI, SUNDHEIM, COVELL & TUMMINO L.L.P., 526 SUPERIOR AVENUE, SUITE 1111, CLEVEVLAND, OH, 44114, US

(73) Assignee: TRW Airbag Systems GmbH

(21) Appl. No.: 11/012,819

(22) Filed: Dec. 15, 2004

(30) Foreign Application Priority Data
Dec. 17, 2003 (DE) 203 19 564.7

(51) Int. Cl. B60R 21/26

(52) U.S. Cl. 280/741

(57) ABSTRACT

A gas generator, in particular for vehicle occupant restraint systems, is provided with a pressure chamber (10) filled with compressed gas, a pyrotechnic igniter (34) arranged outside the pressure chamber (10), a first membrane (14) provided close to the igniter (34) and closing a first opening (12) of the pressure chamber (10), and a second membrane (18) provided further away from the igniter (34) and closing a second opening (16) of the pressure chamber. The first membrane (14) is configured such that it tears at a higher bursting pressure than the second membrane (18).

### TECHNICAL FIELD

The invention relates to a gas generator, in particular for vehicle occupant restraint systems.

### BACKGROUND OF THE INVENTION

A gas generator known from WO 01/42047 A2 comprises a pressure chamber filled with compressed gas, a pyrotechnic igniter arranged outside said pressure chamber, a first membrane provided close to said igniter and closing a first opening of said pressure chamber, a second membrane provided further away from said igniter and closing a second opening of said pressure chamber. The two membranes are destroyed on activation of said igniter. The second opening, which is closed by the second membrane, is the outflow opening for the gas which is released and flows from this opening into a vehicle occupant restraint system. In accordance with this prior art, the second membrane is destroyed by a shock wave which occurs after the destruction of the first membrane and runs through the pressure chamber.

### BRIEF SUMMARY OF THE INVENTION

The invention provides a gas generator in which likewise the second membrane is destroyed by the resulting pressure wave, in which, however, an attempt is to be made to improve the opening behavior (opening speed and reproducibility). The gas generator according to the invention comprises a pressure chamber filled with compressed gas, a pyrotechnic igniter arranged outside said pressure chamber, a first membrane provided close to said igniter and closing a first opening of said pressure chamber, a second membrane provided further away from said igniter and closing a second opening of said pressure chamber. The two membranes are destroyed on activation of said igniter. The first membrane is formed such that it tears at a higher bursting pressure than the second membrane.

Of course, not only the configuration of the membrane itself, but also its surroundings (adjoining walls) is responsible for the bursting pressure, so that the examination of the different bursting pressures must be determined in the actual installation situation. For the determination of the pressure, it is necessary to proceed from the operating state. The first membrane is destroyed by the combustion chamber, more specifically by the pressure arising on activation of the combustion chamber. During the increase in pressure in relation to the combustion chamber, there is always a counter-pressure on the adjacent pressure chamber side of the membrane. The second membrane is then destroyed by the pressure wave which results from the destruction of the first membrane. The pressure then prevailing in the pressure chamber when the second membrane is destroyed is the bursting pressure for the second membrane. The comparison of the pressures is made on the basis of the necessary opening pressure related to the combustion chamber on the one hand and, concerning the second membrane, to the pressure chamber on the other hand.

In the prior art, the first membrane was always substantially smaller than the second membrane and had a lower bursting pressure than the second. This was therefore thus configured because the first membrane was to be opened very rapidly, so that gas could flow out quickly from the gas generator. The invention now surprisingly presents the contrary teaching. Through the as a whole very high bursting pressure of the first membrane, a high pressure must build up in front of it, until the pressure chamber is opened. This means that when the pressure chamber is opened, a higher gas pressure is present outside it than in previous embodiments. Therefore, however, the pressure wave which runs through the pressure chamber and must lead to the destruction of the second membrane becomes stronger. Owing to the stronger pressure wave, however, the second membrane is opened extremely quickly, so that the originally expected disadvantage described above does not occur in the solution according to the invention.

The present invention further provides a gas generator having a pressure chamber filled with compressed gas, a pyrotechnic igniter arranged outside said pressure chamber, a first membrane provided close to said igniter and closing a first opening of said pressure chamber, a second membrane provided further away from said igniter and closing a second opening of said pressure chamber. The two membranes are destroyed on activation of said igniter. A first opening or opening arrangement associated with the first membrane has a cross-sectional area at least equal in size to that of a second opening or opening arrangement associated with the second membrane, the cross-sectional area of the first opening/opening arrangement, however, being preferably larger than that of the second opening/opening arrangement. When the first opening, exposed by the first igniter, is relatively large, the abrupt drop in pressure between the pressure chamber and the adjoining chamber will likewise be very large, which leads to a very strong shock wave. With an equally large or smaller second opening and with a correspondingly dimensioned second membrane, this relatively strong shock wave can then lead to an easy opening thereof.

There also exist embodiments in which a blind is arranged in the immediate vicinity of the membrane. If this blind was arranged in the vicinity of the membrane at a maximum distance of 15 mm and had a smaller diameter than the opening directly closed by the membrane, this blind would determine the pressure ratios if its blind diameter is smaller than that of the opening, because the compensation space between the membrane and the blind would be to small to have a compensation effect. This is the reason why it is defined that blinds which are arranged at a maximum distance of 15 mm upstream and downstream of the membrane and have an entire flow-through cross-sectional area which is smaller than the cross-sectional area of the opening closed by the associated membrane, are used for the comparison of both cross-sectional areas of the openings according to claim 2.

According to the preferred embodiment, no blind or the like, however, is provided, so that the first opening closed by the first membrane has a cross-sectional area which is at least equal in size to that of the second opening closed by the second membrane.

The two membranes are to be oriented in alignment to each other, so that the shock wave can strike directly onto the second membrane.

According to the preferred embodiment, the pressure chamber is configured so as to be elongated, and the openings are provided on the end faces. Preferably, in this connection the gas generator is an elongated tubular gas generator, the length of which amounts to at least three times its external diameter.

The spacing of the membrane should be between five and thirteen times the largest internal diameter of the pressure chamber, which is preferably of circular cylindrical shape over the largest region.

The cross-sectional area of the first opening, as turned out, is to be approximately 1.1 (preferably 1.3) to ten times larger, preferably 1.3 to three times larger than that of the second opening. This ratio has proved to be particularly advantageous for the opening behavior.

With regard to the simple development of the gas generator according to the invention, one embodiment proposes arranging the first membrane directly on the inner side of the cylindrical outer wall of the pressure chamber. Another embodiment, which can likewise be put to practice quite simply, proposes constructing the first membrane as an integral component of the cylindrical outer wall of the pressure chamber. This means that the membrane is not a separate part which is welded on to the outer wall, but rather is produced directly from the start in one piece with the outer wall. This can be achieved for example in that the pressure chamber is delimited by a cylinder wall configured as a separate part and is additionally delimited by a sleeve-shaped closure part. The closure part has a base which forms the first membrane.

A further improvement with regard to a rapid destruction of the second membrane, able to be predetermined within narrow limits, is achieved by the inside of the pressure chamber tapering to the second membrane, preferably close to the latter. Thereby, the shock wave is concentrated in a similar manner like a lens, in order to increase the pressure then acting on the second membrane. This tapering is not to take place in that for example shoulders are provided lying perpendicular to the longitudinal axis and hence to the main direction of flow. These would in fact reflect the shock wave. Rather, provision is made that the tapered section has in the direction of flow from the first to the second membrane exclusively those surfaces which are directed obliquely towards the second membrane. In particular, a funnel-shaped tapering is advantageous here.

The pressure in the pressure chamber before it is opened is also important for the opening behavior and is to be between 240 and 1500 bar.

Helium, a helium/argon mixture or a helium/argon/oxygen mixture is recommended as compressed gas.

The second membrane is to be configured thinner than the first membrane, preferably even so thin that it just withstands the filling pressure plus a safety addition at a temperature of 85 degrees C.

Although theoretically also an individual igniter, if necessary with an booster charge, is sufficient to destroy the first membrane, the preferred embodiment further provides an additional pyrotechnic charge between the igniter and the first membrane, by which hot gas is generated, which mixes with the cold gas in the pressure chamber.

In the very case when a pyrotechnic charge is provided, it can be advantageous to arrange a screen in front of the first membrane, which holds back particles generated on deflagration.

### BRIEF DESCRIPTION OF THE DRAWINGS

FIG. 1 shows a longitudinal sectional view of a first embodiment of the gas generator according to the invention and

FIG. 2 shows a longitudinal sectional view of a second embodiment of the gas generator according to the invention.

### DETAILED DESCRIPTION OF PREFERRED EMBODIMENTS

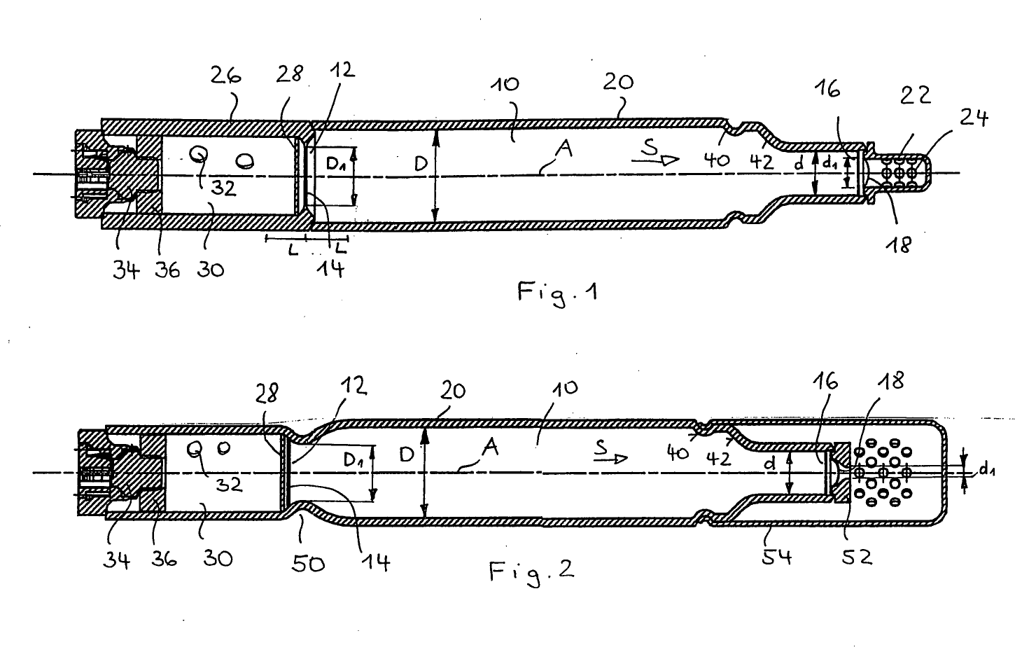

In FIG. 1 an elongated tubular gas generator for inflating a gas bag is shown, which consists of very few individual parts and is distinguished by a good, reproducible opening behavior. The gas generator has a central, elongated, cylindrical pressure chamber 10, which is filled with a compressed gas of helium, a helium/argon mixture or a helium/argon/oxygen mixture at a pressure between 240 and 1500 bar. The pressure chamber 10 has a first, large opening 12 on the left end face, which is closed by a first membrane 14, and also at the opposite end face a second opening 16 of maximum equal size, but preferably smaller, which is closed by a second, smaller membrane 18. The design is made such that the bursting pressure for exposing the first opening 12 is larger than for exposing the second opening 16. The pressure chamber 10 is delimited laterally by a cylindrical outer wall with a cylinder wall 20 configured as a separate part onto which, in the region of the second opening 16, a bush-shaped diffusor 22 is welded, which is provided with radial outflow openings 24. The membrane 18 is welded onto an end face of the diffusor 22, which thereby also functions as a membrane holder.

On the opposite end face, the end face of a sleeve-shaped closure part 26 is welded onto the cylinder wall 20. The base of the sleeve-shaped closure part 26 tapers intensively radially inwards and merges in one piece into the first membrane 14. The first membrane 14 is not, therefore, an individual part which is welded onto an outer wall. In front of the first membrane 14 a blind designed as a screen 28 is arranged, which delimits a combustion chamber 30 which is filled with a pyrotechnic charge 32. An igniter 34 projects into the closure part 26 from the open end face of the sleeve-shaped closure part 26. The igniter is additionally also positioned in a disc-shaped end wall 36 delimiting the combustion chamber 30.

As can be seen from FIG. 1, the cylinder wall 20 is dimensioned uniformly and in a circular cylindrical shape starting from the first membrane 14 and has a uniform internal diameter over almost the entire length. However, towards the second membrane 18, the cylinder wall 20 is configured so as to be tapered in a bottle-neck shape. In this tapering section, the surfaces pointing in the flow direction S (axial direction) are configured so that they are inclined obliquely towards the second membrane 18. These surfaces pointing in flow direction S are designated by 40, 42. Shortly in front of the second membrane 18, the pressure chamber 20 has a section with a uniform internal diameter.

The second membrane 18 is not only thinner than the first membrane 14, it is also distinctly smaller as regards its diameter, just as the second opening 16 (diameter d1) is distinctly smaller than the first opening 12. The cross-sectional area of the associated first opening, here opening 12 is approximately 1.1 to ten times larger than that of the associated second opening, preferably approximately 1.3 to three times larger. In the example embodiment shown, the diameter D1 is actually approximately twice the size of d1.

As already explained and according to the preferred embodiment, the first opening associated with the first membrane 14 should have a cross-sectional area at least equal in size to that of the second opening associated with the second membrane 18. The associated opening of a membrane is that opening or opening arrangement with the smallest flow-through cross section at a distance L upstream and downstream of the membrane 14, 18 or of the opening 12, 16 (FIG. 1) directly closed by the membrane. In the embodiment of FIG. 1, a screen 28, which can be considered as blind, is arranged on the left, i.e. upstream of the membrane 14. Since the entire flow-through cross-sectional area of the screen 28, i.e. its opening arrangement, is larger than the cross-sectional area of the opening 12, the opening 12 is used to compare the openings associated with the membranes 14, 18. At a maximum distance of 15 mm upstream and downstream of the membrane 18, no blinds are provided which narrow the flow cross-section, so that here too, the opening 16 having a diameter d1 is used as a reference scale to the diameter D1 of the first opening 12.

Also the spacing of the membranes 14, 18 from each other is important; it amounts to between approximately five to thirteen times the largest internal diameter D of the pressure chamber 10. The tapering in the region of the second opening 16, furthermore, amounts to at least 30% with respect to the largest diameter D, i.e. the diameter d amounts to less than 70% of the diameter D.

After the activation of the igniter 34, the pyrotechnic charge 32 deflagrates, and the resulting compressed gas destroys the first membrane 14. An abrupt drop in pressure results, through which a so-called shock wave is generated which continues in the flow direction S suddenly through the pressure chamber 10, is concentrated in the region of the tapered end and finally destroys the second membrane 18, so that the mixture of compressed gas and hot gas emerges from the gas generator.

The embodiment according to FIG. 2 corresponds essentially to the one shown in FIG. 1, so that the reference numbers already introduced are used for parts having the same function. With regard to the dimensions of the membranes and of the pressure chamber 10, reference can be made to the above embodiments. It is to be stressed that the individual different features in FIGS. 1 and 2 can be combined with each other as desired.

The embodiment according to FIG. 2 does not have a sleeve-shaped closure part 26; rather, the cylinder wall 20 also extends to beyond the combustion chamber 30. A ring-shaped depression 50 serves for the positioning and fastening of the first membrane 14, which is configured as a separate part and the inner side of which is fixed to the cylinder wall 20 by capacitor discharge welding. At the opposite end, a membrane holder 52 is provided for the second membrane 18, which is configured without a diffusor section but rather has a nozzle-shaped end. A diffusor cap 54, which is fixed to the cylinder wall 20 by crimping, is then placed around the tapered end.

The installation takes place by firstly the pressure chamber 10 being filled with compressed gas via the open second opening 16 with the first opening 12 closed. Then this second opening 16 is closed by means of the second membrane 18.

The circumferential depression 50 forms a blind which lies within the aforementioned maximum distance of 15 mm upstream or downstream of the membrane 14 and its associated opening 12. Since the cross-sectional area with the diameter D1 in the region of the depression 50 is smaller than the cross-sectional area of the first opening 12 and also smaller than the sum of the flow-through cross-sectional areas of the openings of the screen 28, the opening delimited on its inner side by the depression 50 is the opening associated with the membrane 14. This opening with a diameter D1 is distinctly larger than the cross-sectional area with a diameter d1 which is associated with the membrane 18 and in this case is defined by the narrowest location of the membrane holder 52 because at this location, the distance between the membrane holder and the membrane 18 is still less than 15 mm.

In both embodiments, the diameter of the first membrane 14 is maximized; it almost corresponds (up to at least 85%) to the diameter of the pressure chamber 10 directly on the end face with the first opening 12, i.e. almost the entire end wall delimiting the pressure chamber 10 is formed by the membrane 14 and exposed when the gas generator is activated. The igniter 34, the first and the second membrane 14, 18 are oriented in alignment with each other and concentrically to the longitudinal axis A.

1. A gas generator with
a pressure chamber (10) filled with compressed gas,
a pyrotechnic igniter (34) arranged outside said pressure chamber (10),
a first membrane (14) provided close to said igniter (34) and closing a first opening (12) of said pressure chamber (10),
a second membrane (18) provided further away from said igniter (34) and closing a second opening (16) of said pressure chamber,
said two membranes (14, 18) being destroyed on activation of said igniter (34),
wherein
said first membrane (14) is formed such that it tears at a higher bursting pressure than said second membrane (18).

2. The gas generator according to claim 1, wherein one of a first opening (12) and a first opening arrangement associated with said first membrane (14) has a cross-sectional area at least equal in size to that of one of a second opening (16) and an second opening arrangement associated with said second membrane (18).

3. A gas generator with
a pressure chamber (10) filled with compressed gas,
a pyrotechnic igniter (34) arranged outside said pressure chamber (10),
a first membrane (14) provided close to said igniter (34) and closing a first opening (12) of said pressure chamber (10),
a second membrane (18) provided further away from said igniter (34) and closing a second opening (16) of said pressure chamber,
said two membranes (14, 18) being destroyed on activation of said igniter (34),
wherein
one of a first opening (12) and a first opening arrangement associated with said first membrane (14) has a cross-sectional area at least equal in size to that of one of a second opening (16) and an second opening arrangement associated with said second membrane (18).

4. The gas generator according to claim 3, wherein said associated opening is said opening (12 or 16) closed by said respective membrane (14, 18).

5. The gas generator according to claim 3, wherein said associated opening or opening arrangement is one of that opening and opening arrangement of a blind said entire flow-through cross sectional area of which being smaller than said cross-sectional area of said opening (12 or 16) closed by said associated membrane (14, 18), said blind being seated in immediate vicinity of said membrane (14, 18) and having its opening or openings spaced from said associated membrane (14, 18) at a maximum distance of 15 mm.

6. The gas generator according to claim 1, wherein said first and second membranes (14, 18) are oriented in alignment with each other.

7. The gas generator according to claim 1, wherein said pressure chamber (10) is configured in an elongated shape, and said openings (12, 16) are provided on said end faces.

8. The gas generator according to claim 1, wherein said spacing of said membranes (14, 18) is between five and thirteen times said largest internal diameter (D) of said pressure chamber (10).

9. The gas generator according to claim 1, wherein said cross-sectional area of said associated first opening (12) is approximately 1.1 to ten times larger than that of said associated second opening (16).

10. The gas generator according to claim 1, wherein said cross-sectional area of said associated first opening (12) is approximately 1.3 to ten times, particularly approximately 1.3 to three times larger than that of said associated second opening (16).

11. The gas generator according to claim 1, wherein said first membrane (14) is fitted directly to an inner side of a cylindrical outer wall of said pressure chamber (10) or

12. The gas generator according to claim 1, wherein said first membrane (14) is an integral component of a cylindrical outer wall of said pressure chamber (10).

13. The gas generator according to claim 12, wherein said pressure chamber (10) is delimited by a cylinder wall (20) which is configured as a separate part and forms at least a section of said cylindrical outer wall, and by a sleeve-shaped closure part (26), said base of which forms said first membrane (14).

14. The gas generator according to claim 1, wherein said pressure chamber (10) tapers towards said second membrane (18).

15. The gas generator according to claim 14, wherein said tapered section in flow direction (S) from said first to said second membrane (14, 18) has surfaces (40, 42) inclined obliquely exclusively towards said second membrane (18).

16. The gas generator according to claim 1, wherein a pressure between 240 and 1500 bar prevails in said pressure chamber (10) before its being opened.

17. The gas generator according to claim 1, wherein said second membrane (18) is thinner than said first membrane (14).
